(19) United States
(12) Patent Application Publication
(10) Pub. No.: US 2019/0057226 A1
(43) Pub. Date: Feb. 21, 2019

(54) SYSTEM AND METHOD FOR SECURE DATA ACCESS

(71) Applicant: Tod R. Arbutina, Beaver, PA (US)

(72) Inventor: Tod R. Arbutina, Beaver, PA (US)

(21) Appl. No.: 15/896,621

(22) Filed: Feb. 14, 2018

Related U.S. Application Data
(60) Provisional application No. 62/458,784, filed on Feb. 14, 2017.

(51) Int. Cl. G06F 21/64; G06F 17/30; G06Q 30/06

(52) U.S. Cl. CPC G06F 21/64; G06F 17/30979; G06Q 30/0611; G06F 17/30876; G06F 17/30991

(57) ABSTRACT

A method includes providing user data associated with a user to a remote provider system without identifying the user to the remote provider system, wherein the user data includes a certification of the user data recognized by the remote provider system, and wherein the certification of the user data is not provided by the remote provider system. Quote data associated with a service and/or product is received from the remote provider system. The quote data is provided via a user interface to the user, wherein the quote data is associated with an authorization for initiating a process at the remote provider system associated with the service and/or product.

### CROSS REFERENCE TO RELATED APPLICATION

This application claims the benefit of U.S. Provisional Application No. 62/458,784, filed Feb. 14, 2017, the entire disclosure of which is hereby incorporated by reference in its entirety.

### BACKGROUND

Conventional Financial Technology (Fintech) continues to misallocate investment to proprietary, conflicted, duplicative in-house solutions. These issues are becoming particularly acute because of rapidly changing technology, regulatory, and customer demographic changes.

Individuals and families with substantial and growing assets and increasingly complex tax, financial planning, and asset protection requirements need a user friendly, educational, and cost efficient way to integrate their private financial, tax data, and long term wealth management goals.

### SUMMARY

According to some non-limiting embodiments or aspects, provided is a method including providing, with a computer system including one or more processors, user data associated with a user to a remote provider system without identifying the user to the remote provider system, wherein the user data includes a certification of the user data recognized by the remote provider system, and wherein the certification of the user data is not provided by the remote provider system; receiving, with the computer system from the remote provider system, quote data associated with a service and/or product; and providing, with the computer system, the quote data via a user interface to the user, wherein the quote data is associated with an authorization for initiating a process at the remote provider system associated with the service and/or product.

In some non-limiting embodiments or aspects, the certification of the user data is recognized by a plurality of remote provider systems, and the method further includes providing, with the computer system, the user data associated with the user to the plurality of remote provider systems without identifying the user to the plurality of remote provider systems, receiving, with the computer system, the quote data from the plurality of remote provider systems, wherein the quote data is associated with a plurality of quotes for the service and/or product from the plurality of remote provider systems; ranking, with the computer system, the plurality of quotes based on at least one ranking criteria; and providing, with the computer system, a ranked list of the plurality of quotes via the user interface to the user.

In some non-limiting embodiments or aspects, the certification associated with the user data includes a first certification associated with a first portion of the user data and a second certification associated with a second portion of the user data different than the first portion of the user data.

In some non-limiting embodiments or aspects, the method further includes receiving, with the computer system, the first certification from a first remote certification system; and receiving, with the computer system, the second certification from a second remote certification system.

In some non-limiting embodiments or aspects, the method further includes providing, with the computer system, the first remote certification system access to the user data at a first time period; and preventing, with the computer system, the first remote certification system from accessing the user data at a second time period different than the first time period.

In some non-limiting embodiments or aspects, providing the quote data via the user interface to the user includes providing a link for initiating the process at the remote provider system associated with the service and/or product.

In some non-limiting embodiments or aspects, providing the user data associated with the user to the remote provider system without identifying the user to the remote provider system is performed based on at least one trigger criteria.

In some non-limiting embodiments or aspects, the method further includes receiving, with the computer system from the user via a user device, a request to perform a search associated with the product or service, wherein providing the user data associated with the user to the remote provider system without identifying the user to the remote provider system is performed in response to the request.

In some non-limiting embodiments or aspects, the method further includes storing, with the computer system, the user data in a blockchain format.

In some non-limiting embodiments or aspects, the method further includes initiating, with the computer system, the process at the remote provider system associated with the service and/or product based on the quote data; receiving, with the computer system, an indication that the process at the remote provider system associated with the service and/or product is authorized; and identifying, with the computer system, the user to the remote provider system based on the indication.

According to some non-limiting embodiments or aspects, provided is a computing system including one or more processors programmed or configured to provide user data associated with a user to a remote provider system without identifying the user to the remote provider system, wherein the user data includes a certification of the user data recognized by the remote provider system, and wherein the certification of the user data is not provided by the remote provider system; receive quote data associated with a service and/or product; and provide the quote data via a user interface to the user, wherein the quote data is associated with an authorization for initiating a process at the remote provider system associated with the service and/or product.

In some non-limiting embodiments or aspects, the certification of the user data is recognized by a plurality of remote provider systems, and the one or more processors are further programmed or configured to provide the user data associated with the user to the plurality of remote provider systems without identifying the user to the plurality of remote provider systems; receive the quote data from the plurality of remote provider systems, wherein the quote data is associated with a plurality of quotes for the service and/or product from the plurality of remote provider systems; rank the plurality of quotes based on at least one ranking criteria; and provide a ranked list of the plurality of quotes via the user interface to the user.

In some non-limiting embodiments or aspects, the certification associated with the user data includes a first certification associated with a first portion of the user data and a second certification associated with a second portion of the user data different than the first portion of the user data.

In some non-limiting embodiments or aspects, the one or more processors are further programmed or configured to receive the first certification from a first remote certification system; and receive the second certification from a second remote certification system.

In some non-limiting embodiments or aspects, the one or more processors are further programmed or configured to provide the first remote certification system access to the user data at a first time period; and prevent the first remote certification system from accessing the user data at a second time period different than the first time period.

In some non-limiting embodiments or aspects, the quote data provided via the user interface to the user includes a link for initiating the process at the remote provider system associated with the service and/or product.

In some non-limiting embodiments or aspects, the user data associated with the user is provided to the remote provider system without identifying the user to the remote provider system based on at least one trigger criteria.

In some non-limiting embodiments or aspects, the one or more processors are further programmed or configured to receive from the user via a user device, a request to perform a search associated with the product or service, wherein providing the user data associated with the user to the remote provider system without identifying the user to the remote provider system is performed in response to the request.

In some non-limiting embodiments or aspects, the one or more processors are further programmed or configured to store the user data in a blockchain format.

In some non-limiting embodiments or aspects, the one or more processors are further programmed or configured to initiate the process at the remote provider system associated with the service and/or product based on the quote data; receive an indication that the process at the remote provider system associated with the service and/or product is authorized; and identify the user to the remote provider system based on the indication.

Further non-limiting embodiments or aspects are set forth in the following numbered clauses:

Clause 1. A method comprising: providing, with a computer system comprising one or more processors, user data associated with a user to a remote provider system without identifying the user to the remote provider system, wherein the user data includes a certification of the user data recognized by the remote provider system, and wherein the certification of the user data is not provided by the remote provider system; receiving, with the computer system from the remote provider system, quote data associated with a service and/or product; and providing, with the computer system, the quote data via a user interface to the user, wherein the quote data is associated with an authorization for initiating a process at the remote provider system associated with the service and/or product.

Clause 2. The method of clause 1, wherein the certification of the user data is recognized by a plurality of remote provider systems, the method further comprising: providing, with the computer system, the user data associated with the user to the plurality of remote provider systems without identifying the user to the plurality of remote provider systems, receiving, with the computer system, the quote data from the plurality of remote provider systems, wherein the quote data is associated with a plurality of quotes for the service and/or product from the plurality of remote provider systems; ranking, with the computer system, the plurality of quotes based on at least one ranking criteria; and providing, with the computer system, a ranked list of the plurality of quotes via the user interface to the user.

Clause 3. The method of any of clauses 1 and 2, wherein the certification associated with the user data includes a first certification associated with a first portion of the user data and a second certification associated with a second portion of the user data different than the first portion of the user data.

Clause 4. The method of any of clauses 1-3, further comprising: receiving, with the computer system, the first certification from a first remote certification system; and receiving, with the computer system, the second certification from a second remote certification system.

Clause 5. The method of any of clauses 1-4, further comprising: providing, with the computer system, the first remote certification system access to the user data at a first time period; and preventing, with the computer system, the first remote certification system from accessing the user data at a second time period different than the first time period.

Clause 6. The method of any of clauses 1-5, wherein providing the quote data via the user interface to the user includes providing a link for initiating the process at the remote provider system associated with the service and/or product.

Clause 7, The method of any of clauses 1-6, wherein providing the user data associated with the user to the remote provider system without identifying the user to the remote provider system is performed based on at least one trigger criteria.

Clause 8. The method of any of clauses 1-7, further comprising: receiving, with the computer system from the user via a user device, a request to perform a search associated with the product or service, wherein providing the user data associated with the user to the remote provider system without identifying the user to the remote provider system is performed in response to the request.

Clause 9. The method of any of clauses 1-8, further comprising: storing, with the computer system, the user data in a blockchain format.

Clause 10. The method of any of clauses 1-9, further comprising: initiating, with the computer system, the process at the remote provider system associated with the service and/or product based on the quote data; receiving, with the computer system, an indication that the process at the remote provider system associated with the service and/or product is authorized; and identifying, with the computer system, the user to the remote provider system based on the indication.

Clause 11. A computing system comprising: one or more processors programmed or configured to: provide user data associated with a user to a remote provider system without identifying the user to the remote provider system, wherein the user data includes a certification of the user data recognized by the remote provider system, and wherein the certification of the user data is not provided by the remote provider system; receive quote data associated with a service and/or product; and provide the quote data via a user interface to the user, wherein the quote data is associated with an authorization for initiating a process at the remote provider system associated with the service and/or product.

Clause 12. The system of clause 11, wherein the certification of the user data is recognized by a plurality of remote provider systems, wherein the one or more processors are further programmed or configured to: provide the user data associated with the user to the plurality of remote provider systems without identifying the user to the plurality of remote provider systems; receive the quote data from the plurality of remote provider systems, wherein the quote data is associated with a plurality of quotes for the service and/or product from the plurality of remote provider systems; rank the plurality of quotes based on at least one ranking criteria; and provide a ranked list of the plurality of quotes via the user interface to the user.

Clause 13. The system of any of clauses 11 and 12, wherein the certification associated with the user data includes a first certification associated with a first portion of the user data and a second certification associated with a second portion of the user data different than the first portion of the user data.

Clause 14. The system of any of clauses 11-13, wherein the one or more processors are further programmed or configured to: receive the first certification from a first remote certification system; and receive the second certification from a second remote certification system.

Clause 15. The system of any of clauses 11-14, wherein the one or more processors are further programmed or configured to: provide the first remote certification system access to the user data at a first time period; and prevent the first remote certification system from accessing the user data at a second time period different than the first time period.

Clause 16. The system of any of clauses 11-15, wherein the quote data provided via the user interface to the user includes a link for initiating the process at the remote provider system associated with the service and/or product.

Clause 17. The system of any of clauses 11-16, wherein the user data associated with the user is provided to the remote provider system without identifying the user to the remote provider system based on at least one trigger criteria.

Clause 18. The system of any of clauses 11-17, wherein the one or more processors are further programmed or configured to: receive from the user via a user device, a request to perform a search associated with the product or service, wherein providing the user data associated with the user to the remote provider system without identifying the user to the remote provider system is performed in response to the request.

Clause 19. The system of any of clauses 11-18, wherein the one or more processors are further programmed or configured to: store the user data in a blockchain format.

Clause 20. The system of any of clauses 11-19, wherein the one or more processors are further programmed or configured to: initiate the process at the remote provider system associated with the service and/or product based on the quote data; receive an indication that the process at the remote provider system associated with the service and/or product is authorized; and identify the user to the remote provider system based on the indication.

### BRIEF DESCRIPTION OF THE DRAWINGS

FIG. 1 is a diagram of a non-limiting embodiment of an environment in which systems and/or methods, described herein, can be implemented;

FIG. 2 is a diagram of an implementation of a non-limiting embodiment of a management system as disclosed in FIG. 1;

FIG. 3 is a diagram of a non-limiting embodiment of components of one or more devices of FIGS. 1 and 2;

FIG. 4 is a flowchart of a non-limiting embodiment of a process for secure data access;

FIG. 5 is a flowchart of a non-limiting embodiment of a process for secure data access; and

FIG. 6 is a diagram of an implementation of a non-limiting embodiment of a database file structure associated with a process for secure data access as disclosed herein;

FIGS. 7A-7N are diagrams of implementations of non-limiting embodiments of a graphical user interface associated with a process for secure data access disclosed herein; and

FIG. 8 is a diagram of an implementation of a non-limiting embodiment of a process disclosed herein.

### DETAILED DESCRIPTION

The following detailed description of non-limiting embodiments refers to the accompanying drawings. The same reference numbers in different drawings may identify the same or similar elements.

In some non-limiting embodiments, a user may maintain user data (e.g., financial data, etc.) at a proprietary system (e.g., at a proprietary financial management system maintained by a financial institution, etc.). However, the financial institution may not allow the user to fully control his or her own financial data. For example, transfer, and/or access of the user data may be controlled by the financial institution. As an example, a propriety financial management system maintained by a financial institution may not allow a user to switch to a different financial institution while maintaining access to the financial data of the user on a real time basis at the propriety system. In this way, it is more difficult for a user to change service and/or product providers (e.g., financial institutions, insurance providers, etc.) and/or advisors (e.g., certified public accountants (CPAs), independent broker dealers (IBDs), etc.) while maintaining secure, private, and efficient storage, access, and/or transfer of user data.

Further, in some non-limiting embodiments, a service and/or product provider system (e.g., a financial institution, an insurance provider, etc.) may provide a quote or proposal associated with a service and/or product (e.g., a loan, an insurance policy, etc.) available from the service and/or product provider. However, a user may be identified to the service and/or product provider when the quote or proposal is requested. For example, the service and/or product provider system may request and/or require a certification of the user data by a certification entity or system (e.g., a CPA, an IBD, etc.) and/or user data that can be used to identify the user (e.g., a name, a social security number, an email address, a telephone number, etc.) for providing an authorized quote or proposal associated with the product or service, and the user and/or a proprietary financial management system may identify the user when providing the user data for requesting the quote or proposal. In this way, personal identifying user data may be provided to a service and/or product providers before the user determines a service and/or product provider from which the user desires to receive the product or service (e.g., before a purchase decision, etc.). Accordingly, user data that can be used to identify the user is unnecessarily provided to service and/or product provider systems with which the user may not perform a transaction, which reduces the security and privacy of the user data of the user.

As disclosed herein, in some non-limiting embodiments, a computing system including one or more processors is programmed or configured to provide user data associated with a user to a remote provider system without identifying the user to the remote provider system. The user data can include a certification of the user data recognized by the remote provider system, and the certification of the user data may not be provided by the remote provider system. The computing system receives quote data associated with a service and/or product and provides the quote data via a user interface to the user. The quote data can be associated with an authorization for initiating a process at the remote provider system associated with the service and/or product. In this way, more secure, private, and efficient user data storage, access, and/or transfer may be enabled when a user changes service and/or product providers and/or advisors, and the user can obtain a quote or proposal associated with a service and/or product without providing personal identifying user data before the user determines a service and/or product provider from which the user desires to receive the product or service. Accordingly, user data that can be used to identify the user may not be unnecessarily provided to service and/or product provider systems with which the user may not perform a transaction, which increases the security and privacy of the user data of the user.

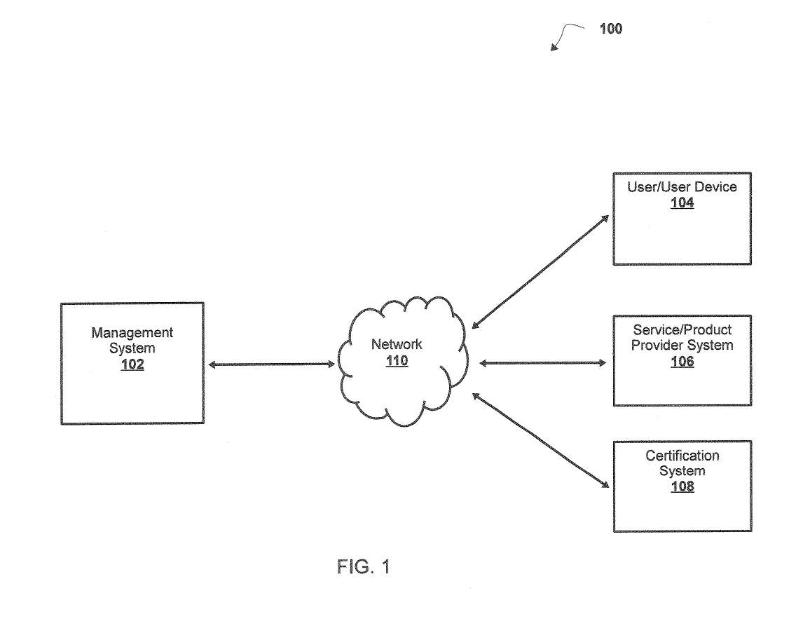

Referring now to FIG. 1, FIG. 1 is a diagram of a non-limiting embodiment of an environment 100 in which systems and/or methods, described herein, can be implemented. As shown in FIG. 1, environment 100 includes management system 102, user/user device 104, service and/or product provider system 106, certification system 108, and network 110. Systems and/or devices of environment 100 can interconnect via wired connections, wireless connections, or a combination of wired and wireless connections.

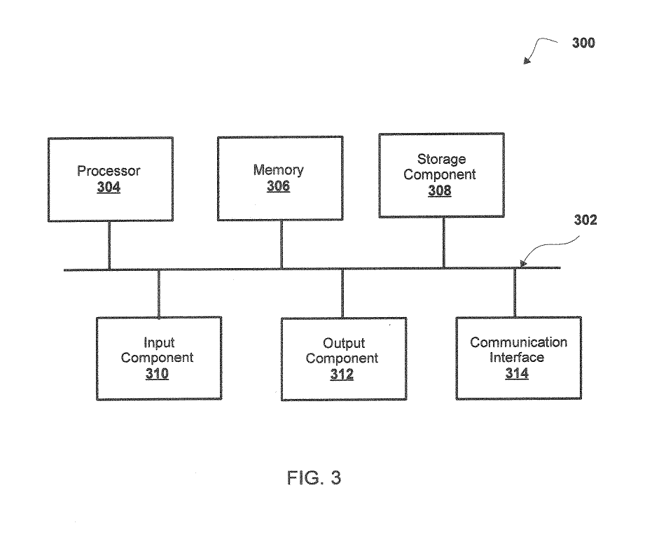

In some non-limiting embodiments, management system 102 includes one or more devices capable of providing user data associated with a user (e.g., a user associated with user device 104, etc.) to service and/or product provider system 106 without identifying the user to service and/or product provider system 106, receiving quote data associated with a service and/or product, and providing the quote data via a user interface to the user (e.g., via a graphical user interface (GUI) of user device 104). In some non-limiting embodiments, the user data includes a certification of the user data recognized by the remote provider system, the certification of the user data is not provided by the remote provider system, and the quote data is associated with an authorization for initiating a process at the remote provider system associated with the service and/or product. For example, management system 102 can include one or more computing systems including one or more processors (e.g., one or more servers, etc.). Further details regarding non-limiting embodiments of management system 102 are provided below with regard to FIG. 3.

In some non-limiting embodiments, user device 104 includes one or more devices capable of providing user data to management system 102 and/or receiving user data from management system 102. For example, user device 104 can include one or more computing systems including one or more processors (e.g., one or more servers, etc.). In some non-limiting embodiments, environment 100 includes a plurality of users (e.g., account holders, etc.) associated with a plurality of user devices 104 as described in more detail herein below.

In some non-limiting embodiments, service and/or product provider system 106 includes one or more device capable of providing receiving user data from management system 102 and/or providing quote data to management system 102. For example, service and/or product provider system 106 can include one or more computing systems including one or more processors (e.g., one or more servers, etc.). In some non-limiting embodiments, environment 100 includes a plurality of service and/or product provider systems 106 as described in more detail herein below. In some non-limiting embodiments, service and/or product provider system 106 includes or is associated with at least one of the following entities: a certified public accountant (CPA), an independent broker dealer (IBD), a tax preparation service, a financial institution, such as a bank, an insurance company, an investment company, a law firm, a medical provider, a government agency, and/or the like.

In some non-limiting embodiments, certification system 108 includes one or more device capable of providing user data and/or a certification of the user data recognized by remote provider system 106 to management system 102, and/or accessing user data at management system 102. For example, certification system 108 can include one or more computing systems including one or more processors (e.g., one or more servers, etc.). In some non-limiting embodiments, environment 100 includes a plurality of certification systems 108 as described herein in more detail below. In some non-limiting embodiments, certification system 108 includes or is associated with at least one of the following entities: a certified public accountant (CPA), an independent broker dealer (IBD), a tax preparation service, a financial institution, such as a bank, an insurance company, an investment company, a law firm, a medical provider, a government agency, and/or the like.

In some non-limiting embodiments, network 110 includes one or more wired and/or wireless networks. For example, network 110 includes a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1 are provided as an example. There can be additional systems, devices and/or networks, fewer systems, devices, and/or networks, different systems, devices and/or networks, or differently arranged systems, devices, and/or networks than those shown in FIG. 1. Furthermore, two or more systems or devices shown in FIG. 1 can be implemented within a single system or a single device, or a single system or a single device shown in FIG. 1 can be implemented as multiple, distributed systems or devices. Additionally, or alternatively, a set of systems or a set of devices (e.g., one or more systems, one or more devices) of environment 100 can perform one or more functions described as being performed by another set of systems or another set of devices of environment 100.

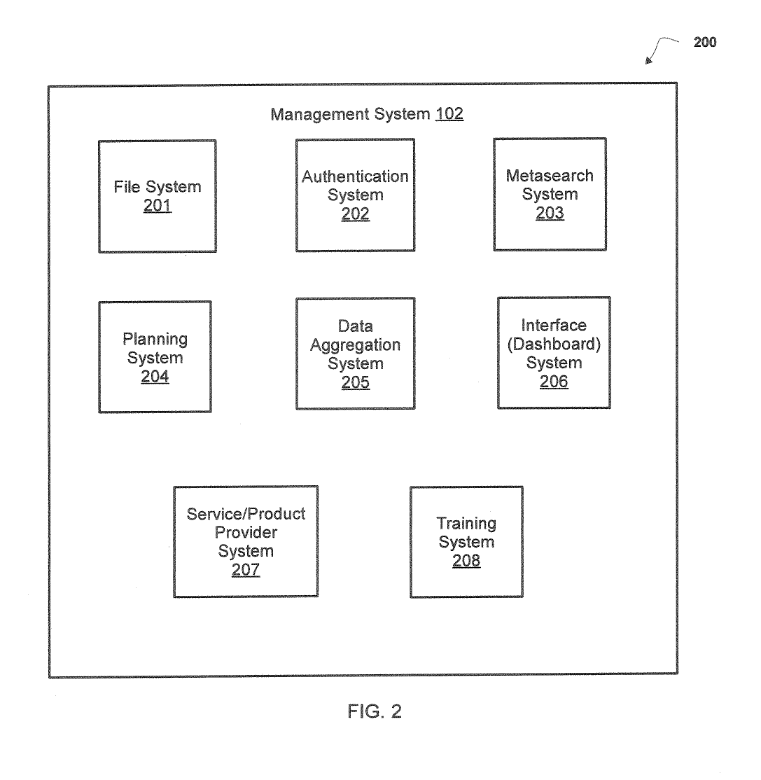

Referring now to FIG. 2, FIG. 2 is a diagram of an implementation 200 of a non-limiting embodiment of management system 102. As shown in FIG. 2, in some non-limiting embodiments, management system 102 is programmed or configured to provide or implement file system 201, authentication system 202, metasearch system 203, planning system 204, data aggregation system 205, interface (dashboard) system 206, service/product provider system 207, and training system 208.

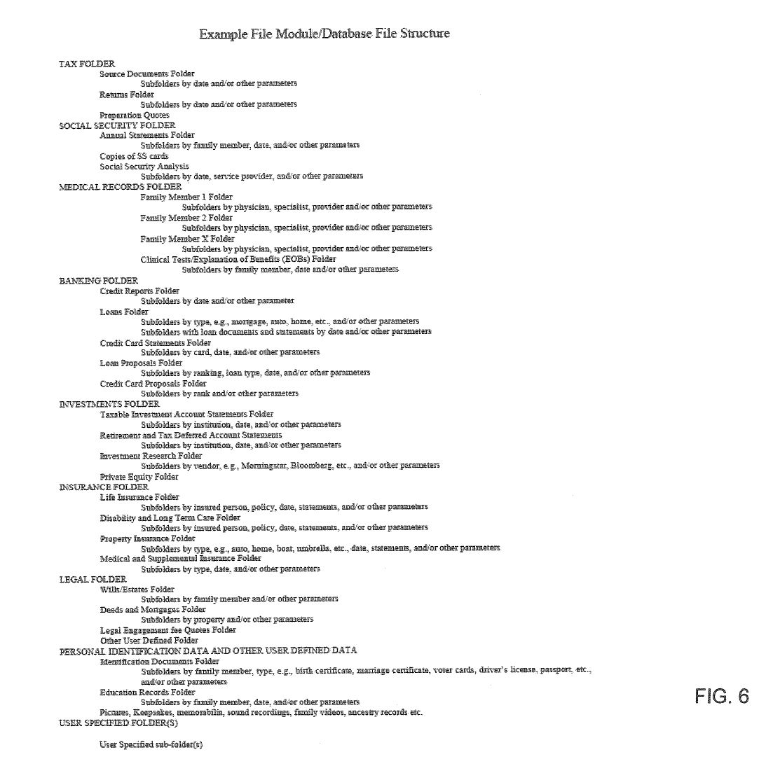

In some non-limiting embodiments, file system 201 is programmed or configured to receive from, manage, and/or provide access to user device 104 associated with a user (e.g., associated with a user account, etc.) to user data stored with file system 201 at management system 102, which may comprise a database or other well-known file structure for storage and management of user data. For example, file system 201 stores aggregated user data associated with user/user device 104, allows the user to access the data via interface (dashboard) system 206 (e.g., provided via user device 104, etc.), and enables to the user to share selected data with service and/or product provider system 106 and/or certification system 108. In some non-limiting embodiments, file system 201 stores the user data in a blockchain format. For example, as user data is received and/or updated, file system 201 can continuously grow the list of records included in the blockchain to update the user data. In some non-limiting embodiments, file system 201 receives and/or stores the user data associated with the user in a database file structure as shown in FIG. 6.

In some non-limiting embodiments, authentication system 202 is programmed or configured to authenticate the user/user device 104 (e.g., a user account associated with the user of user device 104, etc.), and access the user data stored by file system 201 and associated with the user/user device 104. For example, the user data may be stored by file system 201 in association with a user account of the user of user device 104, and authentication system 202 can use a password and/or biometric authentication process performed by the user via user device 104 to enable the user to access the user account and the user data stored by file system 201.

In some non-limiting embodiments, metasearch system 203 is programmed or configured to provide anonymous metasearch capabilities for non-proprietary financial solutions and products, such as tax return preparation, investment advisory, loans (mortgages, auto), life insurance, property and casualty, and other consumer identified products, associated with and/or provided by service and/or product provider systems 106.

In some non-limiting embodiments, planning system 204 is programmed or configured to provide user/user device 104 financial and other types of planning advice via interface (dashboard) system 206 based on the user data stored by the file system 201 associated with the user and/or user data provided by the user to planning system 204. For example, planning system 204 can provide tax compliance advice, investment planning, estate planning, and the like.

In some non-limiting embodiments, data aggregation system 205 is programmed or configured to receive user data associated with the user from the user/user device 104, one or more service and/or product provider systems 106, and/or one or more certification systems 108, and aggregate and store the user data at a single location accessible by the user, e.g., in association with the user account of the user. As an example, data aggregation system 305 can be configured to convert user data from a plurality of different formats into one or more preferred formats to store the user data in the file system 201, enable the user to access the user data via interface (dashboard) system 206 and/or user device 104, and provide selected user data associated with the user (e.g., based on permissions associated with the user account, etc.) to service and/or product provider system 106 and/or certification system 108. Accordingly, user data from different service and/or product provider systems 106 and/or from different certification systems 108 can be combined and/or stored in a same location (e.g., in association with a same user account, etc.). For example, if the user has two different bank accounts at different banks, data aggregation system 205 can receive user data associated with and/or from each bank and store the user data in association with each other and/or in a same folder in file system 201. As an example, user data associated with different service and/or product provider systems 106 can be stored in separate subfolders within a same folder in file system 201. Accordingly, a user associated with the user account can access the user data from different service and/or product provider systems 106 and/or different certification systems 108 at a single location according to some non-limiting embodiments or aspects a management system 102.

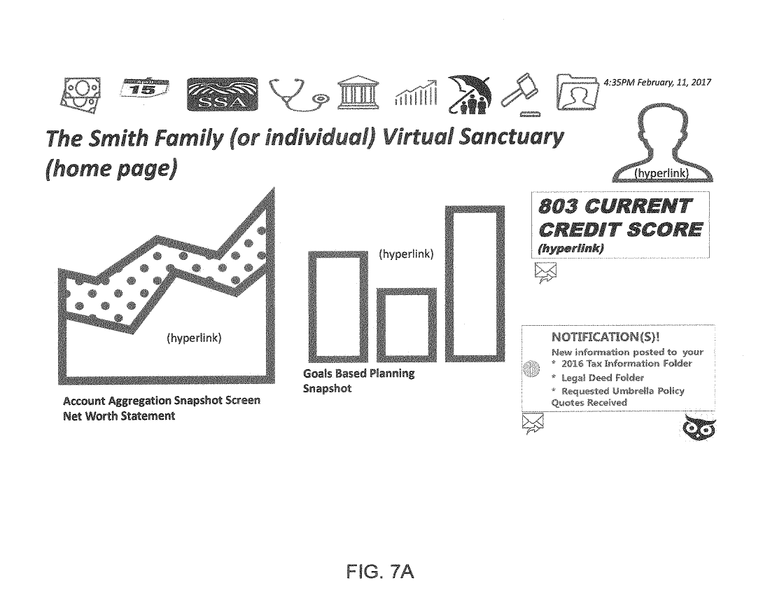

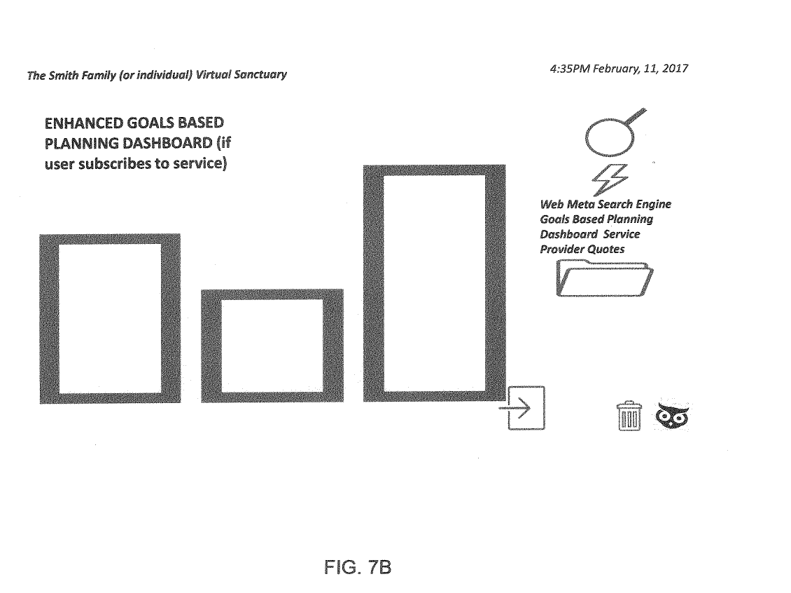

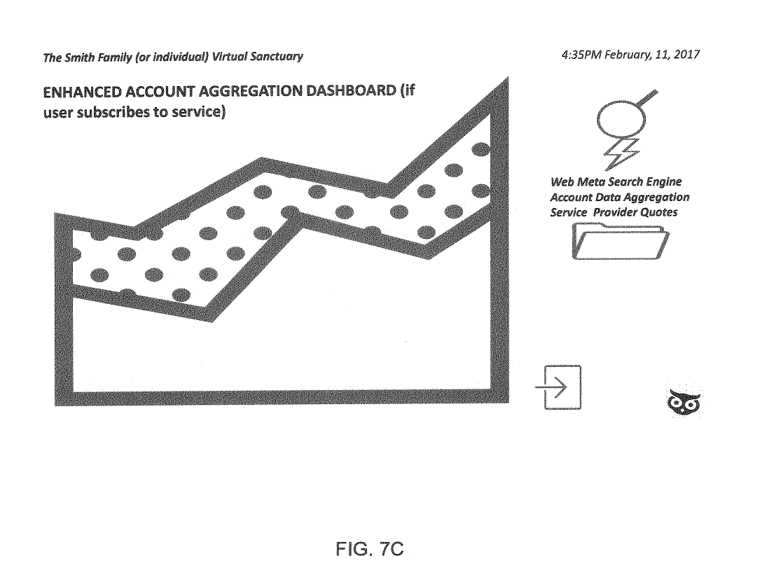

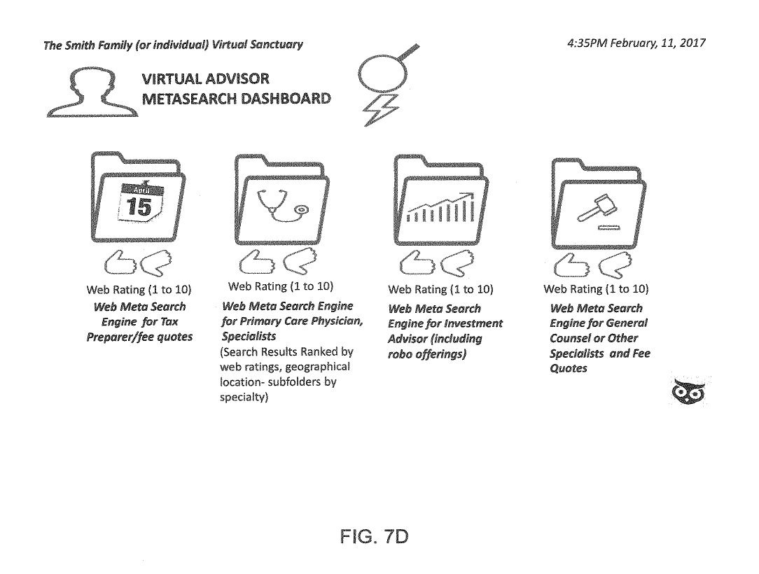

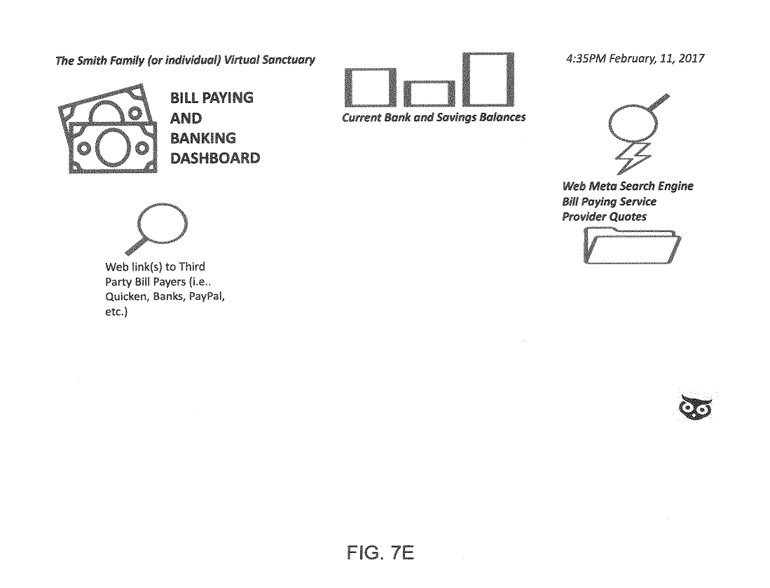

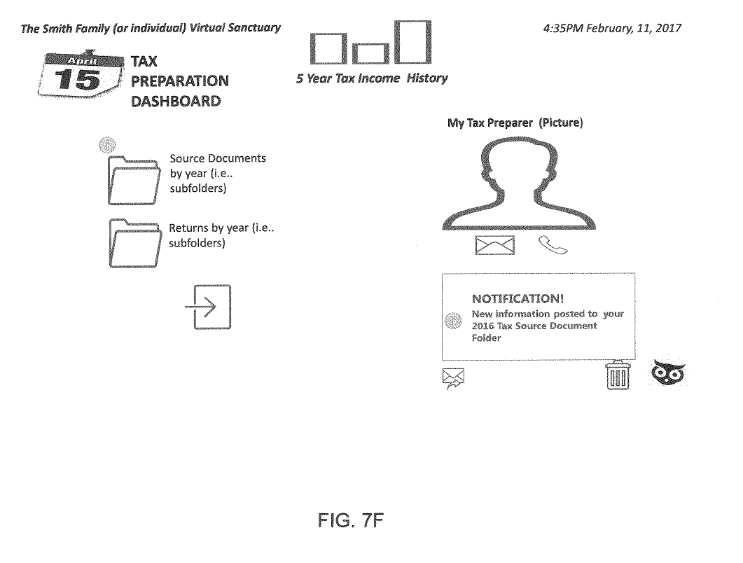

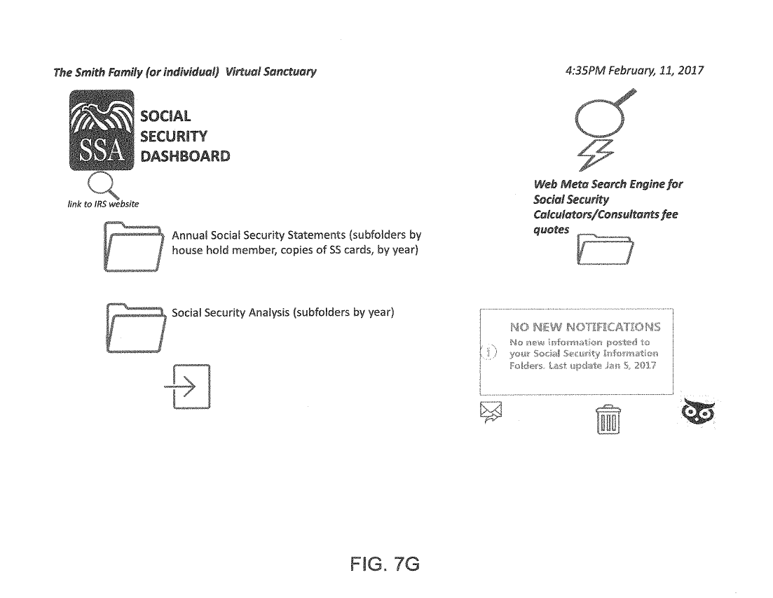

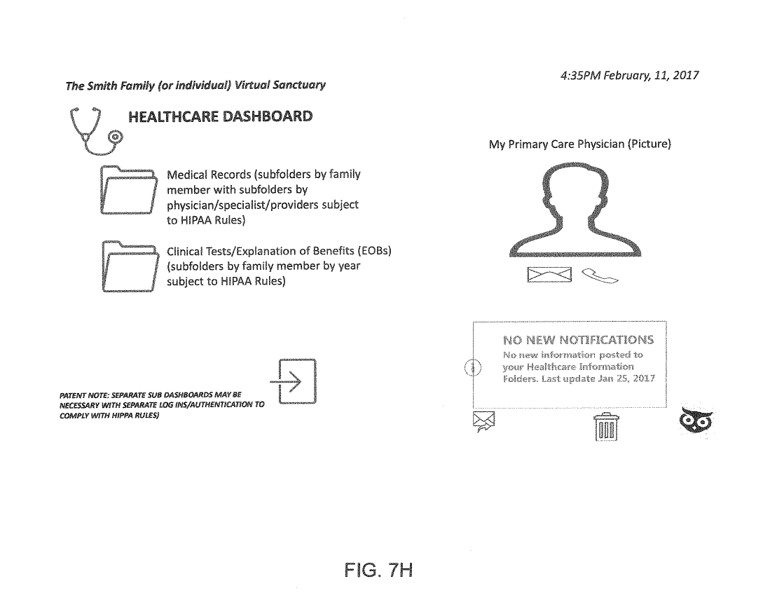

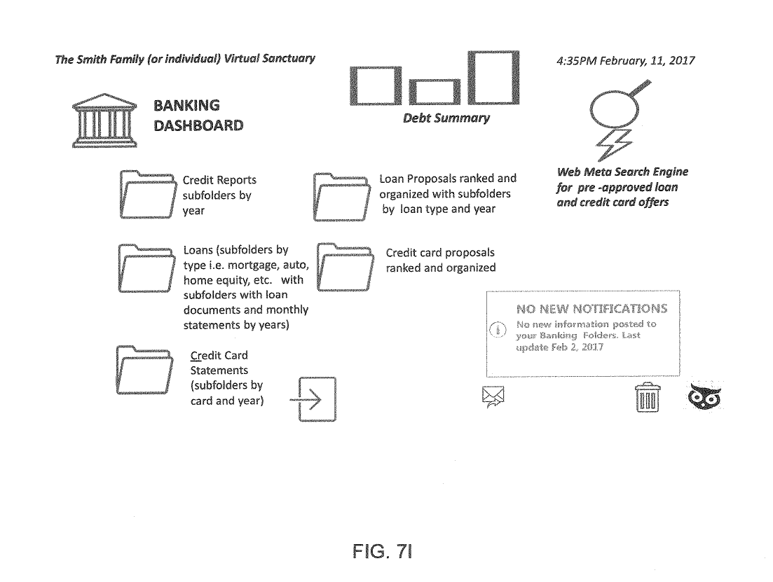

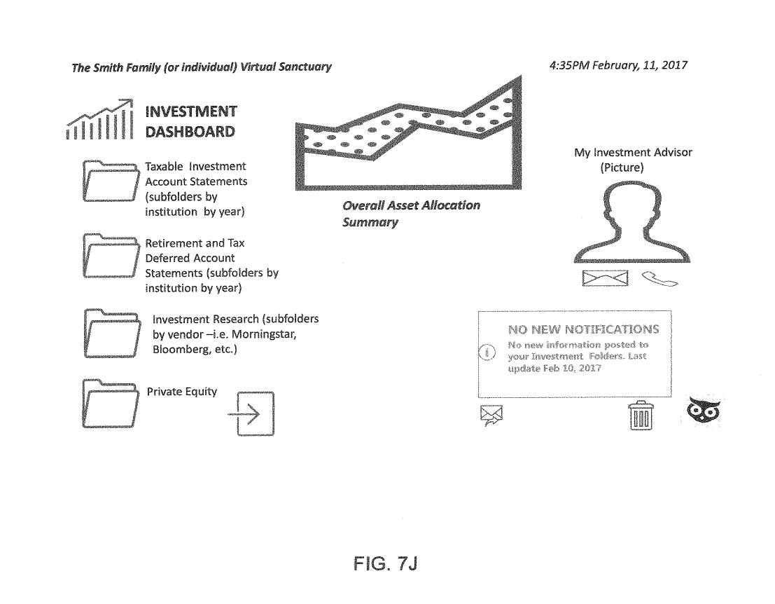

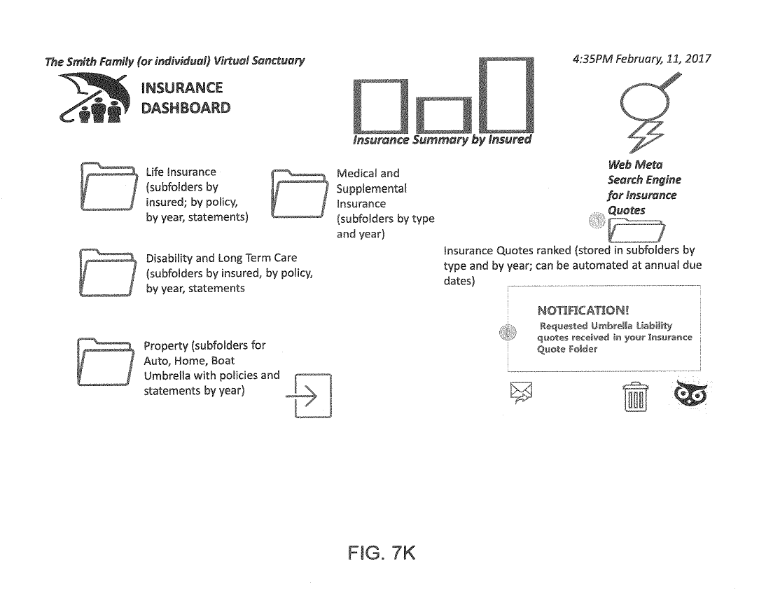

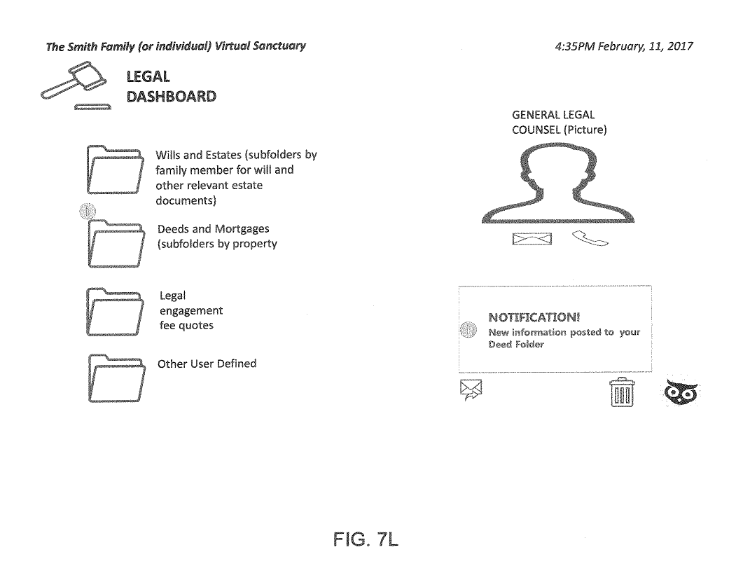

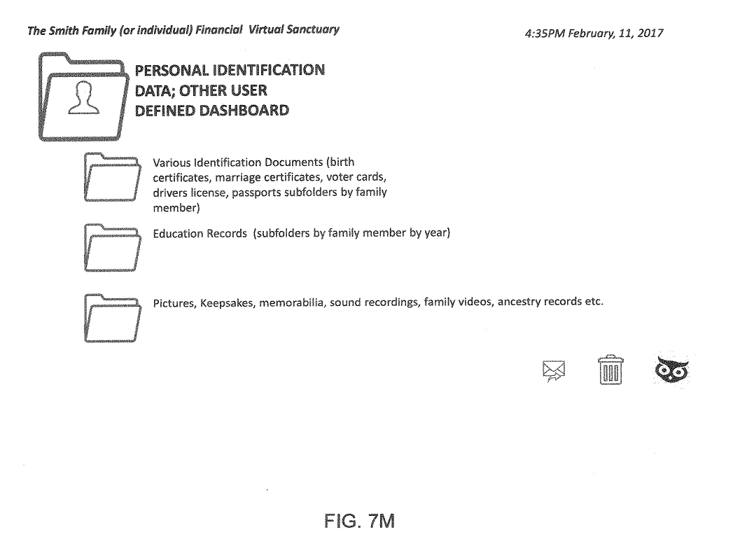

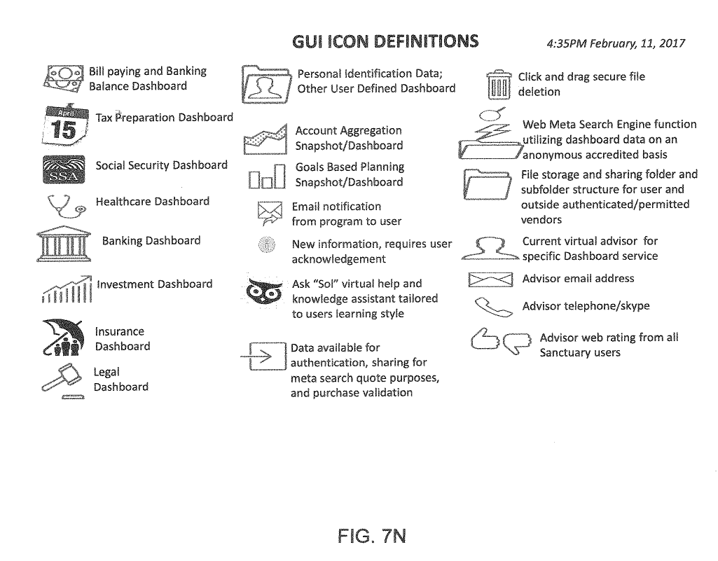

In some non-limiting embodiments, interface (dashboard) system 206 is programmed or configured to provide a graphical user interface for display on user device 104 via which the user can access user data and functions of management system 102 as described herein. For example, interface (dashboard) system 206 may include a web based desk top and/or mobile app which provides a gateway to the metasearch capabilities, planning functions, data aggregation functions, and training functions provided by the management system 102, as well as a secure, private, agnostic file sharing/wealth management dashboard including all data associated with an individual's (or couple or family's) financial planning stored by the file system 201. As an example, FIGS. 7A-7N are diagrams of implementations of non-limiting embodiments of a graphical user interface associated with a process for secure data access disclosed herein. In some non-limiting embodiments, if the user is a business or corporate entity, interface (dashboard) system 206 and corresponding components can be modified to reflect corporate or business market places by providing similar functions related to lending, 401k, various insurances, tax advisors, legal, and the like.

In some non-limiting embodiments, service/product provider system 207 is programmed or configured to provide an interface between management system 102 and service and/or product provider system(s) 106 and/or certification system(s) 108. For example, management system 102 can receive user data and/or quote data associated with users from a plurality of service and/or product provider systems 106 via service/provider system 207 and store the user data and/or the quote data with file system 201 in a database in association with the user account of the user. As an example, service/product provider system 207 can be programmed or configured to provide selected information or data to service and/or product provider system 106 as described herein, for example, in response to a request for a quote for a service and/or product by the user.

In some non-limiting embodiments, training system 208 is configured to provide programs for educating users on how to use and/or interact with management system 102 via user device 104 and/or understand financial and other information included in the user data stored by management system 102. For example, training system 208 can provide educational programs regarding the time value of money, investment games, credit card education, credit scores, and the like to the user via interface (dashboard) system 206 on user device 104. As an example, training system 308 can be programmed or configured as a financial education tool for minors (e.g., middle school through college aged persons), which enables a user to “turn on” additional features, functions, and dashboards as the user matures.

Referring now to FIG. 3, FIG. 3 is a diagram of example components of a device 300. Device 300 can correspond to one or more devices of management system 102, one or more devices (e.g., one or more devices of a system of) user device 104, one or more devices of service and/or product provider system 106, and/or one or more devices of certification system 108. In some non-limiting embodiments, one or more devices of management system 102, one or more devices (e.g., one or more devices of a system of) user device 104, one or more devices of service and/or product provider system 106, and/or one or more devices of certification system 108 can include at least one device 300 and/or at least one component of device 300. As shown in FIG. 3, device 300 includes bus 302, processor 304, memory 306, storage component 308, input component 310, output component 312, and communication interface 314.

Bus 302 includes a component that permits communication among the components of device 300. In some non-limiting embodiments, processor 304 is implemented in hardware, firmware, or a combination of hardware and software. For example, processor 304 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 includes a random access memory (RAM), a read only memory (ROM), and/or another type of dynamic or static storage device (e.g., flash memory, magnetic memory, optical memory, etc.) that stores information and/or instructions for use by processor 304.

Storage component 308 stores information and/or software related to the operation and use of device 300. For example, storage component 308 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 includes a component that permits device 300 to receive information, such as via user input (e.g., a touch screen display, a keyboard, a keypad, a mouse, a button, a switch, a microphone, etc.). Additionally, or alternatively, input component 310 includes a sensor for sensing information (e.g., a global positioning system (GPS) component, an accelerometer, a gyroscope, an actuator, etc.). Output component 312 includes a component that provides output information from device 300 (e.g., a display, a speaker, one or more light-emitting diodes (LEDs), etc.).

Communication interface 314 includes a transceiver-like component (e.g., a transceiver, a separate receiver and transmitter, etc.) that enables device 300 to communicate with other devices, such as via a wired connection, a wireless connection, or a combination of wired and wireless connections. Communication interface 314 can permit device 300 to receive information from another device and/or provide information to another device. For example, communication interface 314 includes an Ethernet interface, an optical interface, a coaxial interface, an infrared interface, a radio frequency (RF) interface, a universal serial bus (USB) interface, a Wi-Fi interface, a cellular network interface, and/or the like.

Device 300 can perform one or more processes described herein. Device 300 can perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device includes memory space located inside of a single physical storage device or memory space spread across multiple physical storage devices.

Software instructions can be read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry can be used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments, device 300 includes additional components, fewer components, different components, or differently arranged components than those shown in FIG. 3. Additionally, or alternatively, a set of components (e.g., one or more components) of device 300 can perform one or more functions described as being performed by another set of components of device 300.

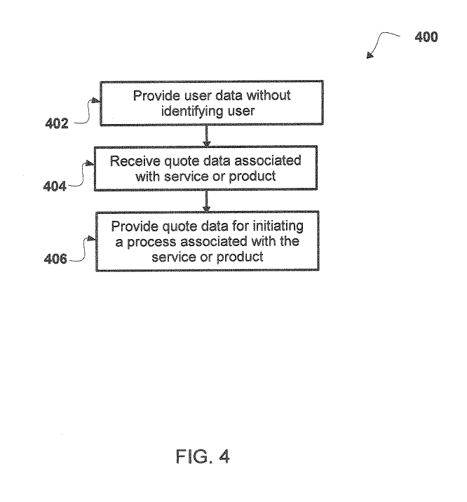

Referring now to FIG. 4, FIG. 4 is a flowchart of a non-limiting embodiment of a process 400 for secure data access. In some non-limiting embodiments, one or more of the steps of process 400 are performed (e.g., completely, partially, etc.) by management system 102 (e.g., one or more devices of management system 102). In some non-limiting embodiments, one or more of the steps of process 400 are performed (e.g., completely, partially, etc.) by another device or a group of devices separate from or including management system 102, such as user device 104 (e.g., one or more devices of user device 104), service and/or product provider system 106, (e.g., one or more devices of service and/or product provider system 106), and/or certification system 108 (e.g., one or more devices of certification system 108).

As shown in FIG. 4, at step 402, process 400 includes providing user data associated with a user to a remote provider system without identifying the user to the remote provider system. For example, management system 102 provides (e.g., provides, transmits, communicates, etc.) user data associated with a user (e.g., a user associated with user device 104 and/or a user account maintained by management system 102, etc.) to service and/or product provider system 106 (e.g., via network 110, etc.) without identifying the user to service and/or product provider system 106. As an example, management system 102 can transmit a metasearch query to service and/or product provider system(s) 106 associated with a service and/or product (e.g., to participating vendors of a service and/or product, etc.) without disclosing information that can be used to identify the user (e.g., a name, a social security number, etc.) or information that can be used to communicate with or contact the user or user device 104 associated with the user (e.g., an street address, an email address, a telephone number, etc.).

In some non-limiting embodiments, user data includes tax data (e.g., data associated with tax source documents or information, tax return documents or information, tax preparation quotes or proposals, etc.), social security data (e.g., data associated with social security statements or information, social security cards, social security analysis, etc.), medical data (e.g., data associated with medical records or information, etc.), banking data (e.g., data associated with credit reports or information, loan documents or information, credit card statements, loan quotes or proposals, credit card quotes or proposals, etc.), investment data (e.g., data associated with taxable investment account statements or information, retirement and tax deferred account statements or information, investment research information, private equity information, etc.), insurance data (e.g., data associated with life insurance documents or information, disability and long term care documents or information, property insurance documents or information, medical and/or supplemental insurance documents or information, etc.), legal data (e.g., data associated with will and/or estate documents or information, deeds and/or mortgage documents or information, legal engagement quotes or proposals, etc.), personal identification data (e.g., data associated with identification documents or information, such as passports, driver licenses, and/or the like, education records or information, such as transcripts, diplomas, and/or the like, pictures, keepsakes, memorabilia, sound recordings, family videos, ancestry records, etc.), user specified data, and/or the like. In some non-limiting embodiments, management system 102 receives and/or stores the user data associated with the user in a database file structure as shown in FIG. 6. In some non-limiting embodiments, management system 102 stores the user data in blockchain format.

In some non-limiting embodiments, the user data includes a certification of the user data recognized by the remote provider system, and the certification of the user data is not provided by the remote provider system. For example, service and/or product provider system 106 can be associated with and/or programmed or configured to automatically recognize, authorize, certify, approve, and/or the like a certification of user data provided by certification system 108 without receiving or analyzing the user data itself and/or an identity of the user. As an example, the user data (e.g., a financial statement, etc.) can be reviewed and confirmed or approved by certifier or validator, such as a certified, independent auditor (e.g., a certified public accountant (CPA), independent broker dealer (IBD), etc.), associated with certification system 108, and management system 102 can receive the certification of the user data from certification system 108.

In some non-limiting embodiments, management system 102 can provide registered certification or verification entities (e.g., certifiers, validators, etc.) access to user data (e.g., documents, statements, etc.) that has been received by management system 102 in association with a user account of a user (e.g., user data available via interface (dashboard) system 206 to a user on user device 104, user data stored in file system 201 and accessible by a user, etc.), and management system 102 can receive from the certification or verification entities confirmation or approval of the user data (e.g., a certification of the user data, etc.). For example, certifiers or validators may include one or more of the following entities: a CPA, the Internal Revenue Service (IRS), a doctor, an individual or group confirmed to have credentials to verify the existence and/or validity of a certain document, set of documents, and/or files, and/or the like.

In some non-limiting embodiments, management system 102 can provide a certifier or validator with access to user data based on one or more permissions defined by a user. As an example, a certifier or validator may be provided with access only to user data that the certifier or validator has been authorized to access by the user. In some non-limiting embodiments, management system 102 can provide a certifier or validator with access to user data based on a type of the user data and/or a location at which the user data is received via interface (dashboard) system 206 and/or stored in file system 201.

In some non-limiting embodiment, management system 102 can provide a certifier or validator access to user data based on credentials associated with the certifier or validator. As an example, a certifier or validator may be provided with access only to user data that can be confirmed or approved by that certifier or validator. For example, a doctor may be provided with access only to user data associated with medical documents and/or files (e.g., user data associated with data stored in medical records folders in file system 201). For example, the IRS may be provided with access only to user data associated with tax documents and/or files (e.g., user data associated with data stored in tax folders in file system 201). Accordingly, by providing a certification or validation of user data, a certifier or validator may confirm an existence and contents of the documents and/or files, which lends credibility and validity to an origin and/or veracity of the documents and/or files.

In some non-limiting embodiments, management system 102 confirms and exposes a transaction associated with user data to be certified by a certifier or validator on a public blockchain ledger. For example, participants to the transaction (e.g., a user, a certifier or validator associated with certification system 108, etc.) can be registered to a publicly available address, and a certification or validation of the user data associated with the transaction can be written and stored to the public ledger via which the certification or validation can be accessed for confirmation. Accordingly, management system 102 may act as a 3rd-party certification or verification tool that enables users to submit documents and/or files to certifiers or validators, such as governing authorities, credit underwriters, and/or the like in order to streamline a process of application submission across a myriad of use cases.

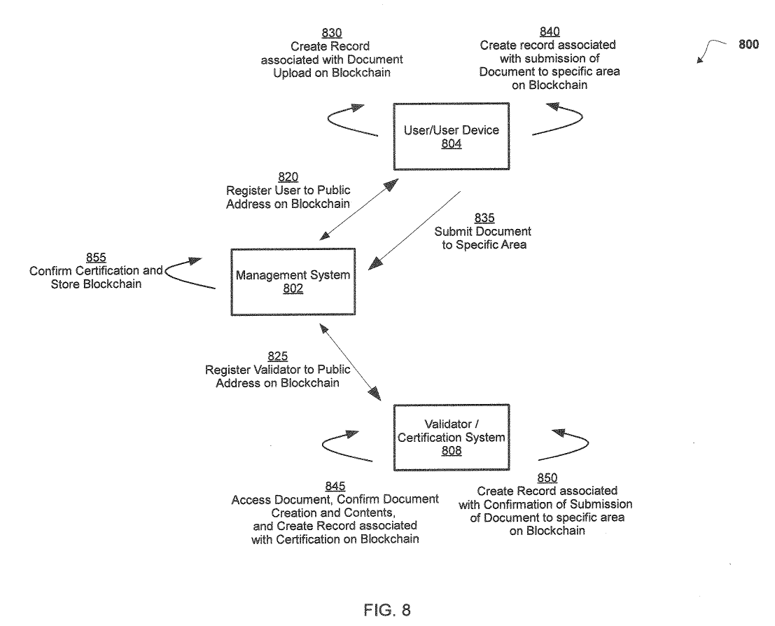

For example, referring now to FIG. 8, FIG. 8 is a diagram of an overview of a non-limiting embodiment of an implementation 800 relating to a process for secure data access. As shown in FIG. 8, implementation 800 may include management system 802, user/user device 804, and validator/certification system 808. In some non-limiting embodiments, management system 802 may be the same as or similar to management system 102. In some non-limiting embodiments, user/user device 804 may be the same as or similar to user/user device 104. In some non-limiting embodiments, validator/certification system 808 may be the same as or similar to validator/certification system 108.

As shown by reference number 820 in FIG. 8, management system 802 can register a user associated with user device 804 to a publicly available address on a public blockchain. As shown by reference number 825 in FIG. 8, management system 802 can register a validator associated with certification system 808 to a publicly available address on the same public blockchain. As shown by reference number 830 in FIG. 8, user/user device 804 can create a record associated with upload of a document to the blockchain and/or management system 802 on the blockchain. As shown by reference number 835 in FIG. 8, user/user device 804 can submit the document via a specific area, for example, a specific area of interface (dashboard) system 206 and/or to a specific area of file system 201 (e.g., via a tax preparation dashboard and/or to a tax preparation folder, etc.), of management system 802. As shown by reference number 840 in FIG. 8, user/user device 804 and/or management system 802 can create a record associated with submission of the document via the specific area of interface (dashboard) system 206 and/or to the specific area of file system 201 on the blockchain. As shown by reference number 845 in FIG. 8, the validator associated with certification system 808 can access the document using the blockchain, confirm creation and contents of the document to provide a certification or verification of the document, and create a record associated with a certification or verification of the document on the blockchain. As shown by reference number 850 in FIG. 8, the validator associated with certification system 808 can create a record associated with confirmation of submission to the specific area of interface (dashboard) system 206 and/or to the specific area of file system 201 on the blockchain. As shown by reference number 855 in FIG. 8, management system 808 can confirm the certification of the document and store the Blockchain including the document and the certification of the document.

In some non-limiting embodiments, a certification includes a certified copy of a document including an endorsement or certification associated with certification system 108 (e.g., a statement, a graphic seal, etc.). In some non-limiting embodiments, a certification includes an electronic certificate including data that enables identification of certification system 108.

In some non-limiting embodiments, a certification associated with user data includes a first certification associated with a first portion of the user data and a second certification associated with a second portion of the user data different than the first portion of the user data. For example, management system 102 can receive the first certification from a first service and/or product provider system 106 and receive the second certification from a second service and/or product provider system 106 different than the first service and/or product provider system 106. As an example, first financial data associated with a first banking account of a user can be certified by a first CPA or financial institution and second financial data associated with a second banking account of the user can be certified by another different CPA or financial institution. In some non-limiting embodiments, management system 102 can provide the first service or product provider system 106 access to the user data at a first time period, and prevent the first service or product provider system 106 from accessing the user data at a second time period different than the first time period. For example, the user can control which entities (e.g., other users, service and/or product provider system(s) 106, certification system(s) 108, etc.) can access user data associated with the user at management system 102. As an example, the user owns and controls his or her private data and can change financial service providers at the user's discretion on a real time virtual basis instead of maintaining the user data a proprietary portal of the financial service provider.

In some non-limiting embodiments, providing the user data associated with the user to the remote provider system without identifying the user to the remote provider system is performed based on at least one trigger criteria. For example, management system 102 can provide the user data associated with the user to service and/or product provider system 106 without identifying the user to service and/or product provider system 106 based on a least one trigger criteria. In some non-limiting embodiments, the at least one trigger criteria is associated with at least one of the following: a periodic time basis, a predetermined or user defined time period, a type of the user data, a receipt of new user data, an update or change to existing user data, and/or the like. As an example, management system 102 can determine that a user has a mortgage interest deduction based on tax return data (e.g., based on data received via a tax return preparation process, etc.), and based on the determination that the user has the mortgage interest deduction, request quotes for mortgage interest rates from participating lenders.

In some non-limiting embodiments, management system 102 receives, from the user via user device 104, a request to perform a search associated with the product or service, and provides the user data associated with the user to service and/or product provider system 106 without identifying the user to service and/or product provider system 106 in response to the request. For example, management system 102 can receive a search query from the user via user device 104 requesting a quote for a service and/or product, (e.g., life insurance, etc.). As an example, management system 102 can conduct the search, for example, by requesting quotes from service and/or product provider systems 106 based on financial information included in the user data associated with the user, but without disclosing to the service and/or product provider systems 106 the identity and contact information of the user. As an example management system 102 can provide service and/or product provider systems 106 with information such as the user's credit score, liabilities, assets, location, age, etc. to enable to service and/or product provider systems 106 to provide an accurate quote for the user without providing service and/or product provider systems 106 with any information that enables service and/or product provider systems 106 to identify the individual user, such as a name, social security number, address, and/or the like associated with the user.

As further shown in FIG. 4, at step 404, process 400 includes receiving quote data associated with a service and/or product. For example, management system 102 receives quote data associated with a service and/or product from service and/or product provider system 106. As an example, management system 102 receives results of a metasearch query sent to service and/or product provider system(s) 106 associated with a service and/or product (e.g., to participating vendors of a service and/or product, etc.).

In some non-limiting embodiments, quote data is associated with a quote or proposal for a service and/or product from service and/or product provider system 106. For example, a quote or proposal can include at least one of the following: a quote or proposal for tax return preparation, a quote or proposal for investment advisory services, a quote or proposal for a loan (e.g., a loan for a home mortgage, a loan for an automobile purchase, etc.), a quote or proposal for insurance (e.g., life insurance, home insurance, auto insurance, casualty insurance etc.), a quote or proposal for a user identified product, and/or the like.

In some non-limiting embodiments, quote data is associated with an authorization for initiating a process at the remote provider system associated with the service and/or product. For example, quote data can be associated with an automatic initiation, execution, and/or approval of a process by a user and/or user device 104 associated with management system 102 at service and/or product provider system 106 associated with the quote data including the authorization. As an example, the quote data may preauthorize a user associated with management system 102 for receiving the service and/or product from service and/or product provider system 106 without identifying the user to service and/or product provider system 106, and management system 102 can provide the quote data including the authorization to the user associated with a corresponding request for quotes associated with the product or service. For example, management system 102 can store quotes returned as a result of a search associated with a user in a corresponding folder of the user associated with a type of the quotes (e.g., a Loan Proposals Folder and/or subfolders thereof for a search for quotes for a loan as shown in FIG. 6).

As further shown in FIG. 4, at step 406, process 400 includes providing the quote data via a user interface to the user. For example, management system 102 provides the quote data via a user interface to the user. As an example, management system 102 store the quote data in a database file structure as shown in FIG. 6, which the user can access via a graphical user interface provided via user device 104.

In some non-limiting embodiments, providing the quote data via the user interface to the user includes providing a link for initiating the process at the remote provider system associated with the service and/or product. For example, management system 102 can provide the quote data via the user interface by providing a link for initiating the process at service and/or product provider system 106 associated with the service and/or product. As an example, management system 102 can provide a hyperlink or graphical icon which can be selected by the user via a graphical user interface provided on user device 104 to initiate the process at service and/or product provider system 106 associated with the service and/or product.

In some non-limiting embodiments, the certification of the user data is recognized by a plurality of remote provider systems. For example, management system 102 can provide user data associated with a user to a plurality of remote provider systems without identifying the user to the plurality of remote provider systems and receive quote data from the plurality of remote provider systems. As an example, the quote data can be associated with a plurality of quotes for the service and/or product from the plurality of remote provider systems. In some non-limiting embodiments, management system 102 ranks the plurality of quotes based on at least one ranking criteria and provides a ranked list of the plurality of quotes via the user interface to the user. For example, management system 120 can receive and filter/sort the quotes associated with a service and/or product based on one or more criteria, such as cost, a comparison to parameters requested by the user, a location of service and/or product provider 106 associated with the quote, and/or the like. As an example, management system 102 can store life insurance quotes for the user in an Insurance Quotes folder of an Insurance Folder in a database file structure as shown in FIG. 6 in an order or arrangement based on the ranking of the quotes and/or a type of the quotes. For example, an Insurance Quotes folder as shown in FIG. 6 may be divided into subfolders associated with specific types of insurance, such as life, auto, home, and/or the like, and management system 102 can store the quotes in the corresponding folder for the determined type of the quotes according to the determined ranking of the type of quote.

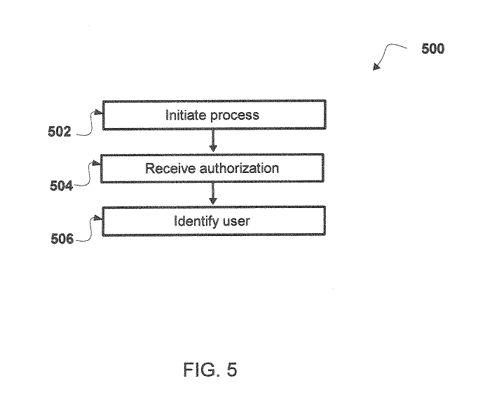

Further details regarding step 406 of process 400 are provided below with regard to FIG. 5.

Referring now to FIG. 5, FIG. 5 is a flowchart of a non-limiting embodiment of a process 500 for secure data access. In some non-limiting embodiments, one or more of the steps of process 500 are performed (e.g., completely, partially, etc.) by management system 102 (e.g., one or more devices of management system). In some non-limiting embodiments, one or more of the steps of process 500 are performed (e.g., completely, partially, etc.) by another device or a group of devices separate from or including management system 102, such as user device 104 (e.g., one or more devices of user device 104), service and/or product provider system 106 (e.g., one or more devices of service and/or product provider system 106) and/or certification system 108 (e.g., one or more devices of certification system 108).

As shown in FIG. 5, at step 502, process 500 includes initiating the process at the remote provider system associated with the service and/or product based on the quote data. For example, management system 102 initiates the process at service and/or product provider system 106 associated with the service and/or product based on the quote data. As an example, management system 102 can initiate a communication link (e.g., an application programming interface (API), etc.) with service and/or product provider system 106 associated with the quote data (e.g., a link associated with the quote data, etc.) and transmit an authorization associated with the quote data to service and/or product provider system 106. As an example, service and/or product provider system 106 may automatically approve and/or complete at least a portion of the process for approving a user associated with the process initiated by management system 102 at service and/or product provider system 106 for receiving a product and/or service associated with the process based on the authorization without identifying the user associated with process.

As further shown in FIG. 5, at step 504, process 500 includes receiving an indication that the process at the remote provider system associated with the service and/or product is authorized. For example, management system 102 receives an indication that the process at service and/or product provider system 106 associated with the service and/or product is authorized. As an example, management system 102 receives an indication of approval and/or completion of at least a portion of the process (e.g., a loan application, an insurance application, etc.) for approving a user associated with the process initiated by management system 102 for receiving the product or service (e.g., a loan, an insurance policy, etc.) from service and/or product provider system 106.

As further shown in FIG. 5, at step 506, process 500 includes identifying the user to the remote provider system based on the indication. For example, management system 102 identifies the user to the service and/or product provider system 106 based on the indication. As an example, management system 102 provides user data including information that can be used to identify the user (e.g., a name, a social security number, etc.) or information that can be used to communicate with or contact the user or user device 104 associated with the user (e.g., an street address, an email address, a telephone number, etc.) to the service and/or product provider system 106. As an example, service and/or product provider system 106 may complete a remainder of the process for approving the user associated with the process initiated by management system 102 at service and/or product provider system 106 for receiving the product and/or service associated with the process and/or provide the product and/or service to the user based on the identification of the user. For example, management system 102 can receive an indication of approval and/or issuance of the product and/or service to the user from service and/or product provider system 106.

The foregoing disclosure provides illustration and description, but is not intended to be exhaustive or to limit the implementations to the precise form disclosed. Modifications and variations are possible in light of the above disclosure or may be acquired from practice of the implementations.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such, Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method comprising:
providing, with a computer system comprising one or more processors, user data associated with a user to a remote provider system without identifying the user to the remote provider system, wherein the user data includes a certification of the user data recognized by the remote provider system, and wherein the certification of the user data is not provided by the remote provider system;
receiving, with the computer system from the remote provider system, quote data associated with a service and/or product; and
providing, with the computer system, the quote data via a user interface to the user, wherein the quote data is associated with an authorization for initiating a process at the remote provider system associated with the service and/or product.

2. The method of claim 1, wherein the certification of the user data is recognized by a plurality of remote provider systems, the method further comprising:
providing, with the computer system, the user data associated with the user to the plurality of remote provider systems without identifying the user to the plurality of remote provider systems,
receiving, with the computer system, the quote data from the plurality of remote provider systems, wherein the quote data is associated with a plurality of quotes for the service and/or product from the plurality of remote provider systems;
ranking, with the computer system, the plurality of quotes based on at least one ranking criteria; and
providing, with the computer system, a ranked list of the plurality of quotes via the user interface to the user.

3. The method of claim 1, wherein the certification associated with the user data includes a first certification associated with a first portion of the user data and a second certification associated with a second portion of the user data different than the first portion of the user data.

4. The method of claim 3, further comprising:
receiving, with the computer system, the first certification from a first remote certification system; and
receiving, with the computer system, the second certification from a second remote certification system.

5. The method of claim 4, further comprising:
providing, with the computer system, the first remote certification system access to the user data at a first time period; and
preventing, with the computer system, the first remote certification system from accessing the user data at a second time period different than the first time period.

6. The method of claim 1, wherein providing the quote data via the user interface to the user includes providing a link for initiating the process at the remote provider system associated with the service and/or product.

7. The method of claim 1, wherein providing the user data associated with the user to the remote provider system without identifying the user to the remote provider system is performed based on at least one trigger criteria.

8. The method of claim 1, further comprising:
receiving, with the computer system from the user via a user device, a request to perform a search associated with the product or service, wherein providing the user data associated with the user to the remote provider system without identifying the user to the remote provider system is performed in response to the request.

9. The method of claim 1, further comprising:
storing, with the computer system, the user data in a blockchain format.

10. The method of claim 1, further comprising:
initiating, with the computer system, the process at the remote provider system associated with the service and/or product based on the quote data;
receiving, with the computer system, an indication that the process at the remote provider system associated with the service and/or product is authorized; and
identifying, with the computer system, the user to the remote provider system based on the indication.

11. A computing system comprising:
one or more processors programmed or configured to:
provide user data associated with a user to a remote provider system without identifying the user to the remote provider system, wherein the user data includes a certification of the user data recognized by the remote provider system, and wherein the certification of the user data is not provided by the remote provider system;
receive quote data associated with a service and/or product; and
provide the quote data via a user interface to the user, wherein the quote data is associated with an authorization for initiating a process at the remote provider system associated with the service and/or product.

12. The system of claim 11, wherein the certification of the user data is recognized by a plurality of remote provider systems, wherein the one or more processors are further programmed or configured to:
provide the user data associated with the user to the plurality of remote provider systems without identifying the user to the plurality of remote provider systems;
receive the quote data from the plurality of remote provider systems, wherein the quote data is associated with a plurality of quotes for the service and/or product from the plurality of remote provider systems;
rank the plurality of quotes based on at least one ranking criteria; and
provide a ranked list of the plurality of quotes via the user interface to the user.

13. The system of claim 11, wherein the certification associated with the user data includes a first certification associated with a first portion of the user data and a second certification associated with a second portion of the user data different than the first portion of the user data.

14. The system of claim 13, wherein the one or more processors are further programmed or configured to:
receive the first certification from a first remote certification system; and
receive the second certification from a second remote certification system.

15. The system of claim 14, wherein the one or more processors are further programmed or configured to:
provide the first remote certification system access to the user data at a first time period; and
prevent the first remote certification system from accessing the user data at a second time period different than the first time period.

16. The system of claim 11, wherein the quote data provided via the user interface to the user includes a link for initiating the process at the remote provider system associated with the service and/or product.

17. The system of claim 11, wherein the user data associated with the user is provided to the remote provider system without identifying the user to the remote provider system based on at least one trigger criteria.

18. The system of claim 11, wherein the one or more processors are further programmed or configured to:
receive from the user via a user device, a request to perform a search associated with the product or service, wherein providing the user data associated with the user to the remote provider system without identifying the user to the remote provider system is performed in response to the request.

19. The system of claim 11, wherein the one or more processors are further programmed or configured to:
store the user data in a blockchain format.

20. The system of claim 11, wherein the one or more processors are further programmed or configured to:
initiate the process at the remote provider system associated with the service and/or product based on the quote data;
receive an indication that the process at the remote provider system associated with the service and/or product is authorized; and
identify the user to the remote provider system based on the indication.
